(19) United States
(12) Patent Application Publication
(10) Pub. No.: US 2015/0302522 A1
(43) Pub. Date: Oct. 22, 2015

(54) WEATHER RELATED PURCHASE GUARANTY FOR PAYMENT NETWORKS

(71) Applicant: MASTERCARD INTERNATIONAL INCORPORATED, Purchase, NY (US)

(72) Inventor: Justin X. Howe, Oakdale, NY (US)

(73) Assignee: MASTERCARD INTERNATIONAL INCORPORATED, Purchase, NY (US)

(21) Appl. No.: 14/255,675

(22) Filed: Apr. 17, 2014

(51) Int. Cl. G06Q 40/04; G06Q 10/02

(52) U.S. Cl. CPC G06Q 40/04; G06Q 10/02

(57) ABSTRACT

Processor-executable methods, computing systems, and related processing for the creation, transaction, administration, management and communication of data relating to weather-related guarantees or insurance policies on travel related expenditures made over a payment card system for protecting against loss of value, or otherwise agreed upon conditions, relating to unpredictable weather or other natural phenomenon.

### FIELD OF INVENTION

The present disclosure relate to systems and methods for providing customizable weather-related purchase guarantees or insurance to cardholders using payment card transactions.

### BACKGROUND

Consumer enjoyment of goods and services may often be dependent on relatively unpredictable natural events, such as weather. For example, a winter vacation involving snow-sports may be wholly or partially affected by a lack of snowfall, the presence of rain, or even unseasonably warm temperatures. Likewise, all or part of a beach vacation may be detrimentally affected by unfavorable weather conditions such as rain, cloudy skies, tropical storms and the like. Similar situations exist for other pay-for-viewing events, such as outdoor sporting events or concerts that may be subject to cancelation due to inclement weather.

In the context of vacation and travel, travel providers often offer insurance to purchasers. These policies are generally based on illness, death, or other such conditions. For example, there may be a reimbursement of airfare in the event of flight cancellations, or reimbursement of hotel or lodging expenses in the event a traveler is unable to reach his destination, due to one or more of conditions occurring under the policy. Third party providers may offer weather-related travel insurance as well. A merchant may offer these options, particularly in the case of third party insurance providers, as a subsequent purchase option solicited through direct mail after a customer's information has been shared with the provider.

As set forth above, these policies often protect a consumer in the event he is unable to reach his destination, or otherwise undertake the vacation or trip. However, no further consideration is made regarding the quality of the trip or vacation once an intended destination is reached. Moreover, in the event of a valid guarantee or insurance policy claim, the refund process is often time-consuming and complex. Alternative systems and methods are desired.

### SUMMARY

In embodiments, systems and computer-implemented methods provide for the generation of offers of insurance on travel-related payment card transactions for protection against weather or other natural phenomenon. In one embodiment, the system includes one or more data storage devices for storing payment card transaction data of a plurality of customers or purchasers. The payment card transaction data includes customer information and payment card transaction amounts. The system includes a memory device storing instructions thereon. The instructions may be executed by a processor for identifying customers who have made travel related expenditures based on processing payment card transaction data, wherein the payment card transaction data includes at least customer information, travel destination, and transaction amounts. The processing further includes analysis of multiple payment card transactions and aggregation of select transactions sufficiently related geographically and categorically for generating an estimated travel itinerary associated with a given destination for the identified customer. The system is configured to compare the estimated travel itinerary for the identified customer with historic, current or forecasted weather data corresponding to the travel destination, for the purpose of generating an offer of travel insurance that includes weather-specific conditions, to the identified customer.

One or more customizable weather-related conditions may be selected by the customer for generating one or more insured events corresponding to the travel related purchase transactions. The payment card network stores in a data base the weather- related criteria or conditions for payment according to the terms of the guarantee policy. Subsequent to commencement of the weather-related guarantee to the cardholder, a processor evaluates weather data of the travel destination received from a weather data feed and compares with the weather-related policy criteria or conditions, to determine if a weather-related condition of the insured event is satisfied. Based on the determination that one or more weather-related conditions is satisfied, the processor is configured to automatically generate a payment card transaction that refunds at least part of the original travel-related payment card transaction. In one embodiment, the one or more weather-related conditions are stored in a database and the processor periodically compares the stored weather-related conditions with a weather data feed according to the cardholder's itinerary for determining whether the one or more weather- related conditions are satisfied.

### BRIEF DESCRIPTION OF THE DRAWINGS

FIG. 1 illustrates a system architecture within which some embodiments of the present disclosure may be implemented.

FIG. 2 is a functional block diagram of a managing computer system for a payment card service provider in accordance with an exemplary embodiment of the present disclosure.

FIG. 3 illustrates a system for providing services related to cardholder- customizable weather related guarantees or insurance on payment card purchases.

FIG. 4 illustrates exemplary transaction record data useful in implementing aspects of the present system and method.

FIG. 5 illustrates an exemplary process flow for generating a database of identified travel itineraries, generating exemplary insurance policies, and making offers of insurance to cardholders.

FIG. 6 illustrates another exemplary process flow for automatically generating refunds to cardholders in the event a weather-related condition of the insurance policy has been met.

FIG. 7 illustrates exemplary itinerary data associated with multiple payment card transactions aggregated in accordance with an embodiment of the present disclosure.

### DETAILED DESCRIPTION

Disclosed herein are processor-executable methods, computing systems, and related processing for the creation, distribution, administration, management and communication of data relating to weather data based guarantees or insurance policies on payments made over a payment card system for protecting against loss of value, or otherwise agreed upon conditions, relating to unpredictable weather or other natural phenomenon. While the embodiments of the present disclosure will generally be described as being generated and otherwise administered by a card network, it is envisioned that these policies may originate from an acquirer, an issuer, a merchant service provider or payment network, without departing from the scope of the present invention.

A “payment card processing system” or “credit card processing network” or “card network”, such as the MasterCard network exists, allowing consumers to use payment cards issued by a variety of issuers to shop at a variety of merchants. With this type of payment card, a card issuer or attribute provider, such as a bank, extends credit to a customer to purchase products or services. When a customer makes a purchase from an approved merchant, the card number and amount of the purchase, along with other relevant information, are transmitted via the processing network to a processing center, which verifies that the card has not been reported lost or stolen and that the card's credit limit has not been exceeded. In some cases, the customer's signature is also verified, a personal identification number is required or other user authentication mechanisms are imposed. The customer is required to repay the bank for the purchases, generally on a monthly basis. Typically, the customer incurs a finance charge for instance, if the bank is not fully repaid by the due date. The card issuer or attribute provider may also charge an annual fee.

A “business classification” is a group of merchants and/or businesses, classified by the type of goods and/or service the merchant and/or business provides. For example, the group of merchants and/or businesses can include merchants and/or businesses which provide similar goods and/or services. In addition, the merchants and/or businesses can be classified based on geographical location, sales, and any other type of classification, which can be used to define a merchant and/or business with similar goods, services, locations, economic and/or business sector, industry and/or industry group.

A “merchant category code” or “MCC” is a four-digit number created by MasterCard, for example, and assigned to a business by the acquirer when the business first starts accepting one of these cards as a form of payment. The merchant category code or MCC is used to classify the business by the type of goods or services it provides. For example, in the United States, the merchant category code can be used to determine if a payment needs to be reported to the IRS for tax purposes. In addition, merchant category codes (or MCCs) are used by card issuers to categorize, track or restrict certain types of purchases.

As used herein, the term “processor” broadly refers to and is not limited to a single- or multi-core general purpose processor, a special purpose processor, a conventional processor, a Graphics Processing Unit (GPU), a digital signal processor (DSP), a plurality of microprocessors, one or more microprocessors in association with a DSP core, a controller, a microcontroller, one or more Application Specific Integrated Circuits (ASICs), one or more Field Programmable Gate Array (FPGA) circuits, any other type of integrated circuit (IC), a system-on-a-chip (SOC), and/or a state machine.

It is to be understood that a payment card is a card that can be presented by the cardholder (i.e., customer) to make a payment. By way of example, and without limiting the generality of the foregoing, a payment card can be a credit card, debit card, charge card, stored-value card, or prepaid card or nearly any other type of financial transaction card. It is noted that as used herein, the term “customer”, “cardholder,” “card user,” and/or “card recipient” can be used interchangeably and can include any user who holds a payment card for making purchases of goods and/or services. Further, as used herein in, the term “issuer” or “attribute provider” can include, for example, a financial institution (i.e., bank) issuing a card, a merchant issuing a merchant specific card, a stand-in processor configured to act on-behalf of the card-issuer, or any other suitable institution configured to issue a payment card. As used herein, the term “transaction acquirer” can include, for example, a merchant, a merchant terminal, an automated teller machine (ATM), or any other suitable institution or device configured to initiate a financial transaction per the request of the customer or cardholder.

It is understood that conventional travel insurance generally offers protection against unforeseen circumstances which prevent a traveler or travelers from reaching their desired destination, with no consideration for the quality of their vacation once they have arrived. Embodiments of the present disclosure describe a system and method for providing a weather-related guarantee customizable for select events and conditions based on payment card transaction purchases. In one embodiment, a cardholder purchasing, for example, a vacation, may pay for an additional amount for opt-in weather cancellation insurance, weather guaranty, or weather warranty customizable to his or her personal preferences. These preferences may include, by way of non-limiting example only, selection of given weather criteria, conditions or weather parameters or characteristics that must occur (or not occur) during all or part of the trip or vacation. For example, in the case of a payment card purchase of a ski vacation, an entity (e.g. the cardholder) may specify as a weather criteria the amount of snowfall that needs to occur at the destination vacation locale some period of time up to or during the vacation. Similarly, for a beach vacation payment card transaction purchase, a cardholder may specify as a weather criteria the number of sunny (or non-rainy) days he wishes to guarantee as a weather-related policy condition. The cardholder may execute the guarantee through, for example, the payment card system and pay an additional amount to an entity (e.g. the merchant associated with a transaction purchase or other third party such as a card network or insurance provider). During the vacation, if the stated policy conditions are not met, in whole or in part, a full or partial credit or refund may be directly applied to the cardholder's account via the payment card network according to the terms of the policy. In this way, the value of a credit or refund may be proportional to the number of days a particular policy criteria or condition is not met.

In some embodiments, credits or refunds may occur automatically based on a comparison between the selected weather criteria and the weather at the cardholder's known destination, according to a weather feed imported from one or more predetermined sources, such as the National Weather Service, U.S. Oceanographic Service, or other suitable, weather provider.

In an alternative embodiment, a merchant, issuer, acquirer, merchant service provider, or payment network may provide a blanket guaranty/warranty/insurance having preselected conditions for all cardholders. This blanket guarantee may be tailored to a particular type of trip. For example, a set of predetermined conditions relating to ski trips or summer vacations may be applied to all policies, without the input of a particular cardholder or purchaser. Such blanket guarantees may have different opt-in price amounts, based, for example, on the purchase transaction amounts and events covered as part of the customer's itinerary.

The methods disclosed herein may use active or passive techniques to identify customers and their associated payment card purchases relating to vacation and/or travel plans via an analysis of received transaction data. Transaction data may comprise a multiplicity of payment card transactions records that include customer information, merchant information, and transaction amounts which are subsequently processed to identify purchasers of, for example, travel-related products or services.

In one embodiment, passively collected ISO 8583 information received over the payment card network from all payment card purchases is analyzed and/or filtered by a processor of the card network for the purpose of making an initial identification of cardholders who have purchased, or are in the process of purchasing, goods and services related to vacation or travel. In some embodiments, transaction data filtering may be aimed at, for example, merchant ID numbers, card network codes, transaction dates, transaction type codes, user-provided information, and the like, in order to select particular payment card transactions that relate to a given cardholder's travel itinerary and that may be insured for/against particular weather conditions. Additional information regarding the details of a cardholder's trip, including origins and destinations, the number of passengers, as well as hotel accommodation details, including location, dates and duration, may be provided to a card network. This may be accomplished by, for example, clearing addenda received after the payment card transaction purchases have been completed. Alternatively, other methods of gathering data relating to a particular trip may be implemented. For example, the system may infer the occurrence of a particular cardholder check-in at a hotel from check-in payment card authorizations received over the payment card network. Trip details may also be received in response to an inquiry sent to a cardholder after a vacation or trip purchase has been identified. More specifically, embodiments may also provide a means for a customer actively desiring insurance to reach out to a card network, for example, by telephone or website interface, and provide the details of his or her trip to the card network.

Using this information, one or more analytic engines may be configured to predict or generate a model travel itinerary comprised of a plurality of identified trip attributes for an identified cardholder. The engine is configured to identify and aggregate multiple payment card purchases and categories that relate to the same relative geographic location (travel destination) by the same cardholder. Using the above-gathered data, systems and methods according to the present disclosure are configured to setup or populate a database that includes information relating to the travel plans or itinerary of a customer, including specific dates, times and destinations. Similarly, a card network may receive and identify payment card transaction information related to purchased items or event tickets (e.g. outdoor sporting event or outdoor concert) or other paid-for activities which may be associated with an itinerary. These events may be added to the itinerary and stored in the database. The database may be monitored and updated according to additional information received by the card network for any of the itineraries stored thereon.

Once a database has been established and travelers and itineraries identified, one or more weather-related insurance policies and associated premiums or costs may be generated. A computer processor may utilize historic and forecasted weather data and weather premium data requested from outside providers for calculating insurance coverage costs of a particular itinerary. For example, factors including but not limited to a trip's start and end dates, duration, location, historic weather patterns, current weather patterns, and the like may be analyzed by a third party to determine a market rate for insuring all or part of a trip, for any number of weather-related scenarios. This process takes into consideration each of the trip's attributes and their associated costs identified for each itinerary. Generation of a policy premium may be customized according to the particular requirements of a given cardholder.

A policy may include a number of cardholder-customizable policy coverage options. Once generated, an offer of insurance may be presented to an identified cardholder. Such an offer may include a default blanket policy covering the trip according to predetermined criteria. In another embodiment, the offer may include a number of customizable options from which a cardholder may choose. For example, options may include a given number of days of the trip guaranteed to have certain weather conditions. These options may be coded such that a user may email, text, or otherwise communicate a code associated with one or more of these coverage options to a third party, (e.g. the insurance provider), thereby indicating the specific coverage desired, or indicating an agreement to purchase said coverage.

Embodiments of the present disclosure further include a source of weather data, such as an integrated weather data feed, which may take the form of a historical weather database for storing information relating to various weather parameters, including by way of non-limiting example, one or more of temperature, humidity, solarity, wind speed, precipitation, amounts, ranges, averages (e.g. seasonal) dates, times and the like, for geographic locations identified in the itineraries of each customer. This information may be imported from a predetermined source or third party provider. It should be understood that weather data for importation into the database may be selectively requested from the provider according to identified characteristics or attributes of each trip (e.g. destination, duration, etc.), or the database may comprise more comprehensive global weather data accessible at various times according to select characteristics of a particular trip.

One or more processors may be responsive to the policy coverage information and the weather data statistics database to identify weather conditions at a specific location and time corresponding to the itinerary, for making a determination as to the occurrence of the one or more weather related criteria or conditions of the policy (e.g. the occurrence of rain on one or more days of a vacation that may trigger payment of the weather-related insurance policy). The total amount of refund due may be calculated by the processor according to the policy conditions and weather data determined via the weather feed, with the cardholder's account credited accordingly over the card network. This refund process may be automatic, and provided over the card network without the requirement of any further action by the cardholder. According to embodiments of the invention, refunds may be generated and transacted over the payment card network by the merchant, by the issuer, payment network, or a third party insurance provider.

According to further embodiments of the present disclosure, the weather related insurance policy based on one or more payment card transaction purchases may be implemented within the context of opt-in insurance policies at the discretion of the cardholder. Embodiments of the present disclosure may also be implemented as a default process applied to all payment card transaction travel purchases by a cardholder provided by, for example, an issuing bank or payment network.

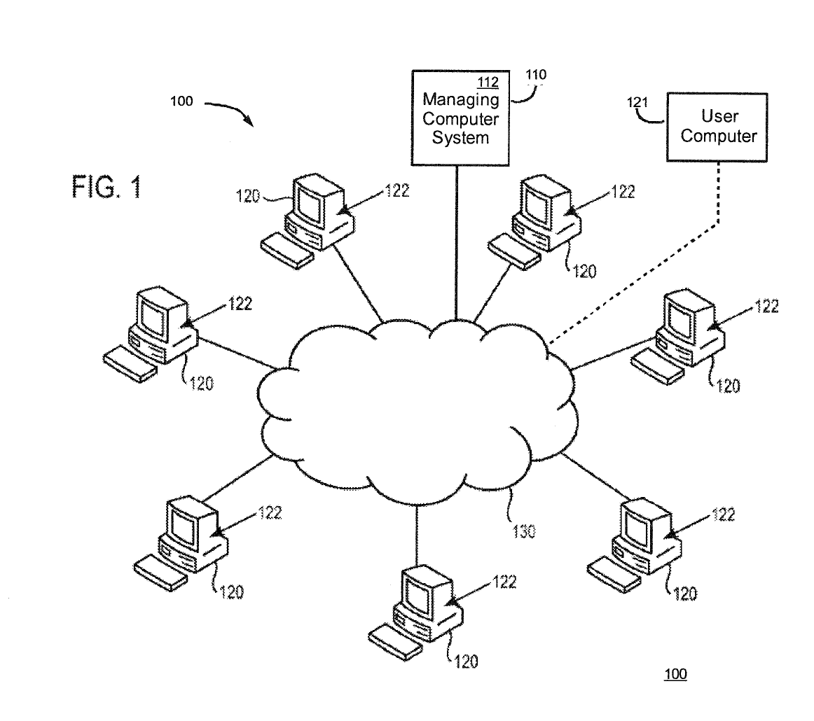

Referring now to FIG. 1, there is shown a high-level diagram illustrating an exemplary system for providing weather-related insurance or guarantees for payment card transactions according to an embodiment of the disclosure. As shown in FIG. 1, the system 100 includes a managing computer system 110 that includes a data store or data warehouse for storing payment card transaction records associated with a card network provider, or payment card service provider 112. Each payment transaction performed by a transaction acquirer and/or merchant 122 having a corresponding merchant computer system 120 is transferred to the managing computer system 110 via a network 130 which connects the computer system 120 of the transaction acquirer or merchant 122 with the managing computer system 110 of the payment card service provider 112. Transactions performed between a customer or cardholder and a transaction acquirer or merchant 122 may comprise point of sale transactions, or electronic point of sale transactions performed via a customer or cardholder computer 121.

The network 130 can be virtually any form or mixture of networks consistent with embodiments as described. These include, but are not limited to, telecommunication or telephone lines, the Internet, an intranet, a local area network (LAN), a wide area network (WAN), virtual private network (VPN) and/or a wireless connection using radio frequency (RF) and/or infrared (IR) transmission to name a few. The network may implement a message format such as the International Standards Organization (ISO) 8583 standard typically used for the banking and financial services sector. As is understood by one skilled in the art, ISO 8583 specifies a message format describing payment card (e.g. credit card and debit card) data that is exchanged between devices and card issuers. The standard is typically used by point-of-sale devices and automated teller machines. The messages themselves commonly contain information about the value of a transaction, where it originated, the card account number, and bank sort code.

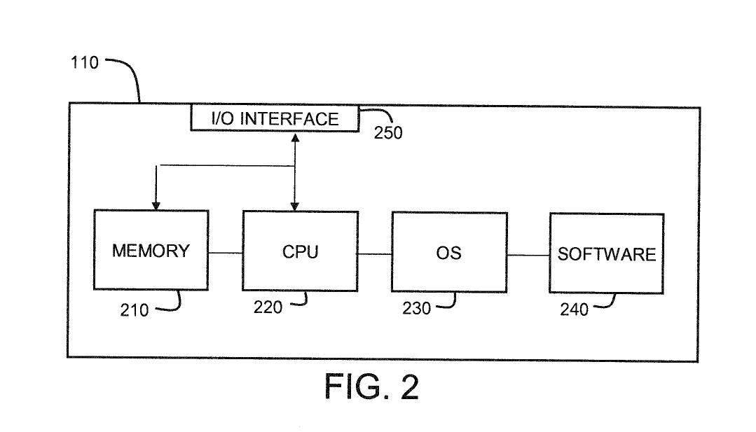

The managing computer system 110 for the payment card service provider 112 as shown in FIG. 2 includes at least one memory device 210 configured to store data that associates identifying information of individual customers, merchants, and transactions associated with payment card accounts. System 110 further includes a computer processor 220, and an operating system (OS) 230, which manages the computer hardware and provides common services for efficient execution of various logic circuitry including hardware, software and/or programs 240. The processor 220 (or CPU) carries out the instructions of a computer program, which operates and/or controls at least a portion of the functionality of the managing computer system 110. System 110 further includes device input/output interface 250 configured to receive and output network and transactions data and information to and/or from managing computer system 110 from and/or to peripheral devices and networks operatively coupled to the system. Such devices may include user 121 and/or merchant 120 terminals, including point of sale terminals, wireless networks and devices, mobile devices and client/server devices, and user interfaces communicatively coupled over one or more networks for interfacing with managing system 110. The I/O interface 250 may include a query interface configured to accept and parse user requests for information based on the payment card transactions data. In addition, the I/O interface may handle receipt of transactions data and perform transactions based processing in response to receipt of transactions data as a result of a particular purchase via a point of sale terminal, by way of non-limiting example only.

The at least one memory device 210 may be any form of data storage device including but not limited to electronic, magnetic, optical recording mechanisms, combinations thereof or any other form of memory device capable of storing data, which associates payment card transactions of a plurality of transaction acquirers and/or merchants. The computer processor or CPU 220 may be in the form of a stand-alone computer, a distributed computing system, a centralized computing system, a network server with communication modules and other processors, or nearly any other automated information processing system configured to receive data in the form of payment card transactions from transaction acquirers or merchants 122. The managing computer system 110 may be embodied as a data warehouse or repository for the bulk payment card transaction data of multiple customers and merchants. In addition, the computer system 120 or another computer system 121 (e.g. user computer of FIG. 1) connected to computer system 110 (via a network such as network 130) may be configured to request or query the managing computer system 110 in order to obtain and/or retrieve information relating to categories of customers, merchants, and services associated therewith, based on information provided via the computer system 120 or 121 and profiling of the transaction data contained in computer system 110 according to the particular query/request.

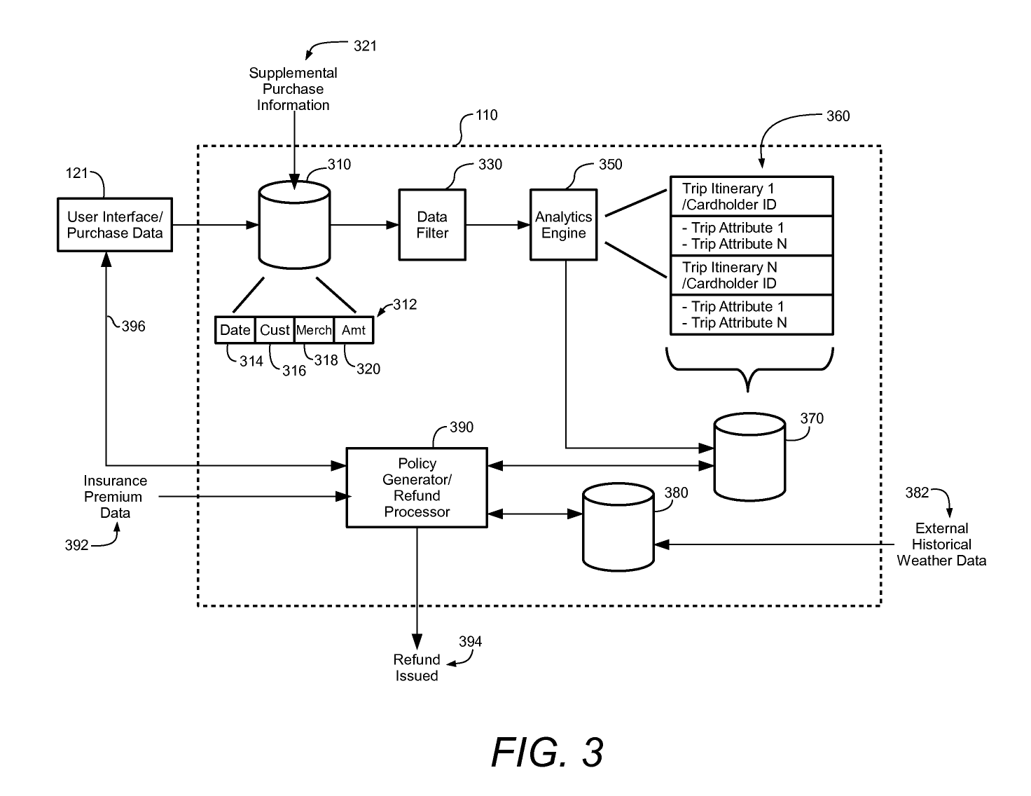

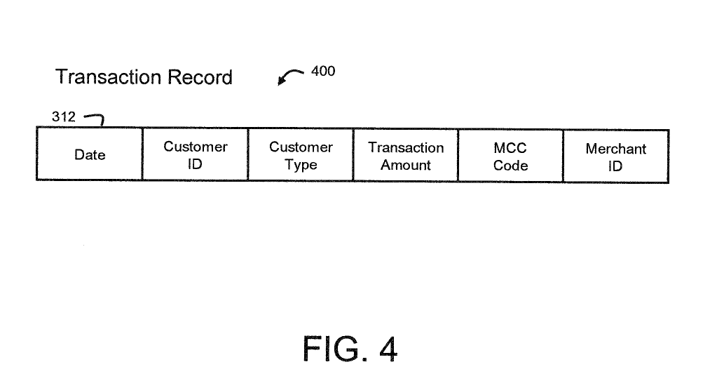

Referring now to FIG. 3, there is shown a system block diagram and operational flow for creating, transacting, administering, and managing weather-related guarantees or insurance policies on payment card transactions made over a card network for protecting against loss of value associated with the transaction, or other agreed upon conditions, due to weather or other natural phenomenon (e.g. hurricane, earthquake, etc.), according to an exemplary embodiment of the present disclosure. A database 310 containing a multiplicity of payment card transaction data is included in managing computer system 110 (FIGS. 1 and 2) and updated continuously for new merchant/customer payment card transactions. The payment card transaction records 312 may be obtained via various transaction mechanisms, such as credit and debit card transactions between customers and merchants originating via a cardholder terminal or computer 121 (e.g. a personal computer) and transacted over the payment card network, which include but are not limited to, on-line payment card transactions. Payment card transaction records may include transaction date 314 as well as customer information 316, merchant information 318 and transaction amount 320. Customer information 316 may further include customer account identifier (ID) and customer type, as provided in an exemplary transaction record illustrated in FIG. 4. Additional information such as MCC code, and geographic region (e.g. city, state, zip code), may also be included. This information may be obtained, for example, by passive means, such as monitoring of ISO 8583 information from all of the payment card transaction purchases over the payment card network. Additional information regarding the details of a particular transaction, such as a payment card purchase of a trip (e.g. airfare), including origins and destinations, the number of passengers, and date, as well as a supplemental payment card transaction, such as hotel accommodation details, including location, dates and duration, may be provided to a card network. This may be obtained, for example, by clearing addenda received after purchases have been completed (herein identified as Supplemental Purchase Information 321) and may further populate database 310 and associate or link the particular transaction information. Other methods of gathering data relating to a particular trip may be implemented. For example, hotel check-in can be inferred from check-in card authorizations. Embodiments may also provide a means for customers actively desiring weather-related insurance for payment card transaction purchases to reach out to a card network, either by telephone or website interface, and provide details of his or her trip to the card network.

As described above, embodiments of the present disclosure target cardholders associated with payment card transactions that indicate upcoming vacation or travel plans. In order to identify these cardholders and associated transactions, payment card transaction data stored in database 310 may be subject to a filtering operation 330 according to the requirements of a particular application in order to selectively identify specific merchants and/or industries from a list of merchants or industries for targeted analysis. By way of non-limiting example only, the transactions data may be filtered according to different rules or targeting criteria, such as merchant type (e.g. travel service companies, airlines, railways, cruise lines, hotels, resorts, tourist attractions, rental car companies, etc.), and transaction amounts for targeted analysis. Filtering may be aimed at various forms of data, such as merchant ID numbers, card network codes, transaction dates, transaction type codes, user-provided information, and the like. Further filtering (e.g. by geographical location, e.g. region, state, county, city, zip code, street) may be applied to further target particular aspects of the transaction data for given applications.

Filtered transaction data relating to travel expenditures is provided to one or more processors, embodied in the illustrated system as analytics engine 350, for further refinement. Analytics engine 350 is configured to profile and categorize the filtered transactions according to logical relationships for the purpose of identifying purchases relating to travel and vacation, associate these purchases with cardholders, and create an estimated or model travel itinerary for each identified trip or for each cardholder. Such itinerary may include, by way of non-limiting example, destination location, travel mode, trip duration, arrival and departure times, as well as activities likely to be pursued on the trip (e.g. trips to a ski resort, or other forms of entertainment). In this way, analytics engine 350 may access database 310 to search for and identify previously unidentified transactions for events and other activities scheduled to take place during an identified vacation or trip, and incorporate these events into an itinerary model for each cardholder or identified trip.

Various types of models and applications may be configured and utilized by analytics engine 350 in order to derive information from the transaction data. The analytics engine utilizes statistical analyses and techniques applied to the payment card transaction data to analyze the payment card transactions records to determine relationships, patterns, and trends between and among the various transaction records. Such statistical analyses may be targeted to particular subsets of the transactions data, including by way of non-limiting example, one or more particular geographic regions, business categories, customer categories, product or service types, and purchasing frequencies. The transaction records may be processed and segmented into various categories in order to determine purchasers of a given type of product or service, such as those relating to travel or vacation, by way of non-limiting example. The analysis engine may utilize independent variables as well as dependent variables representative of one or more purchasing events, customer types or profiles, merchant types or profiles, purchase amounts, and purchasing frequencies, by way of example only. The analysis engine may use models such as regression analysis, correlation, analysis of variances, time series analysis, determination of frequency distributions, segmentation and clustering applied to the transactions data in order to determine and predict the effect particular categories of data have on other categories.

Analytics engine 350 is configured to build an itinerary database 370 which includes information relating to the travel plans of a cardholder, including specific dates, times, destinations and events associated with an identified trip, based on the payment card transactions data. Information may be grouped or otherwise organized and stored within database 370 according to any number of methods, including, but not limited to a particular identified trip, cardholder ID, or a combination thereof. In the exemplary embodiment, analytics engine 350 is operative to determine the particular “non-home” locations at which a cardholder is scheduled to be at, according to specific dates and times based on analysis of the payment card transactions data, and to generate model itineraries 360 (trip itineraries 1-N) for each identified trip for storage within database 370. Each itinerary 360 comprises one or more trip attributes, such as destination, duration, associated dates, as well as pre-planned events and the like associated with an identified trip. Transaction database 310 may be monitored in order to continuously update database 370 and itineraries 360 stored therein with additional related travel or trip information received by the card network and processed by analytics engine 350.

Embodiments of the present disclosure utilize one or more sources of weather data for generating weather-related guarantees or insurance policies, as well as for determining whether payouts are due to a cardholder upon completion (or during) the trip. Accordingly, a system according to an embodiment of the present disclosure may further comprise an integrated weather data feed 382 for providing weather data associated with particular geographic locations or destinations corresponding to those identified in itinerary database 370. The integrated weather data feed 382 may provide weather data including such parameters as temperature, humidity, solarity, wind speed, precipitation, amounts, ranges, averages (e.g. seasonal) dates, times and the like, for select geographic locations. Forecast weather data and historical weather data may also be provided. The weather data may be obtained at predetermined intervals (e.g. hourly intervals, daily, day and night intervals, continuously, etc.) and may be provided based on one or more geographic regions such as zip code, latitude/longitude, airport code, city name, and the like in any appropriate format. In one embodiment, a weather database 380 may implement a continuously updated, comprehensive historical database of global weather data from weather feed 382. In another embodiment, weather database 380 may be selectively populated with only weather data relevant to identified cardholder itineraries destinations.

Analytics engine 350 or other processor may be configured to query an external historical weather source 382 for weather data associated with a time and location corresponding to a particular itinerary stored in database 370. Historical weather data may be imported to database 380 from one or more sources of weather data 382, such as the National Weather Service, U.S. Oceanographic Service, or other suitable, reliable historic weather provider.

Processor 390 may be configured to assist in the communication and generation of proposed weather-related guarantees for each identified itinerary in data base 370. Processor 390 may utilize existing valuations of weather-related insurance premium data 392 (e.g. administered by outside providers) for calculating the cost for guaranteeing a particular itinerary. For example, a given trip's seasonal time, duration, location, historic weather patterns, current weather patterns, and the like may be analyzed to determine a market rate for insuring all or part of a trip, for any number of weather-related scenarios. The process takes into consideration each of the itineraries and the stored attributes and their identified purchase transaction costs. Generated policies may include standardized coverage for an entire trip, as well as options for providing partial trip coverage, such as for insuring a particular number of days of predetermined weather conditions or criteria.

Once provided with the data specific to each itinerary, processor 390 may create an offer for guaranteeing trip coverage options, which may be provided to a cardholder via delivery channel 396. This offer of refund or partial refund based on the occurrence of one or more weather-related criteria may be made via automated text message, direct mail solicitation, e-mail, phone call from the issuer, or through a website interface, by way of non-limiting example. Each of the refund options included in the offer may be coded, such that a user may email, text, or otherwise communicate a code associated with one or more of these options. In this way, a cardholder may pay for extra opt-in weather cancellation insurance, weather guaranty, or weather warranty customizable to their personal preferences. These preferences may include, by way of non-limiting example only, predetermined weather conditions or characteristics that must occur during all or part of a vacation. For example, in the case of a ski vacation, a purchaser may specify the amount of snowfall that needs to occur at his or her destination some period of time up to or during their vacation. Likewise, for a beach vacation, a user may specify the number of sunny or non-rainy days they wish to guarantee, or number of non-cloudy days. The offer of insurance may also include an option for blanket trip coverage. In one embodiment, processor 390 operates merely as a conduit for exchanging information between the cardholder and a third party insurance provider, by correlating the trip itinerary information in the data base 370, obtaining select cardholder weather criteria for insuring the trip, transmitting the relevant information to the insurer, and then coordinating the transaction.

A cardholder may respond to the offer for weather-related trip insurance or guarantee in any suitable manner, including by way of non-limiting example, return text message, email message, telephone confirmation, or online order. Once confirmation of acceptance of an offer for insurance and/or payment therefore has been received, processor 390 may generate a message indicating that a particular itinerary within database 370 is covered by a given policy, as well as associate and store the particular policy details and conditions or criteria for payment for linkage with the itinerary in database 370, or in a separate memory.

Processor 390 may also function as a refund processor for determining whether the conditions of the weather-related guarantee are met. More specifically, processor 390 may be responsive to the policy information and specified criteria linked with a given itinerary stored in database 370, as well as the weather data from weather feed 382. The processor may be configured to correlate particular weather data received in the weather data feed 382 with the weather-related criteria for triggering the guarantee. Processor 390 determines the occurrence of any weather or other environmental occurrences which trigger the protection of the associated guarantee policy. If the required policy conditions are not met, in whole or in part, a full or partial credit or refund may be calculated by processor 390 and directly applied to the cardholder's account via the payment card network. In this way, the value of a credit may be proportional to the number of days a particular criteria or condition is not met in accordance with the policy coverage. Refunds may be provided by the merchant, by the issuer, payment network, or a third party insurance provider.

Each or any combination of the modules and components shown in FIG. 3 may be implemented as one or more software modules or objects, one or more specific- purpose processor elements, or as combinations thereof. Suitable software modules include, by way of example, an executable program, a function, a method call, a procedure, a routine or sub-routine, one or more processor-executable instructions, an object, or a data structure. In addition or as an alternative to the features of these modules described above with reference to FIG. 3, these modules may perform functionality described later herein.

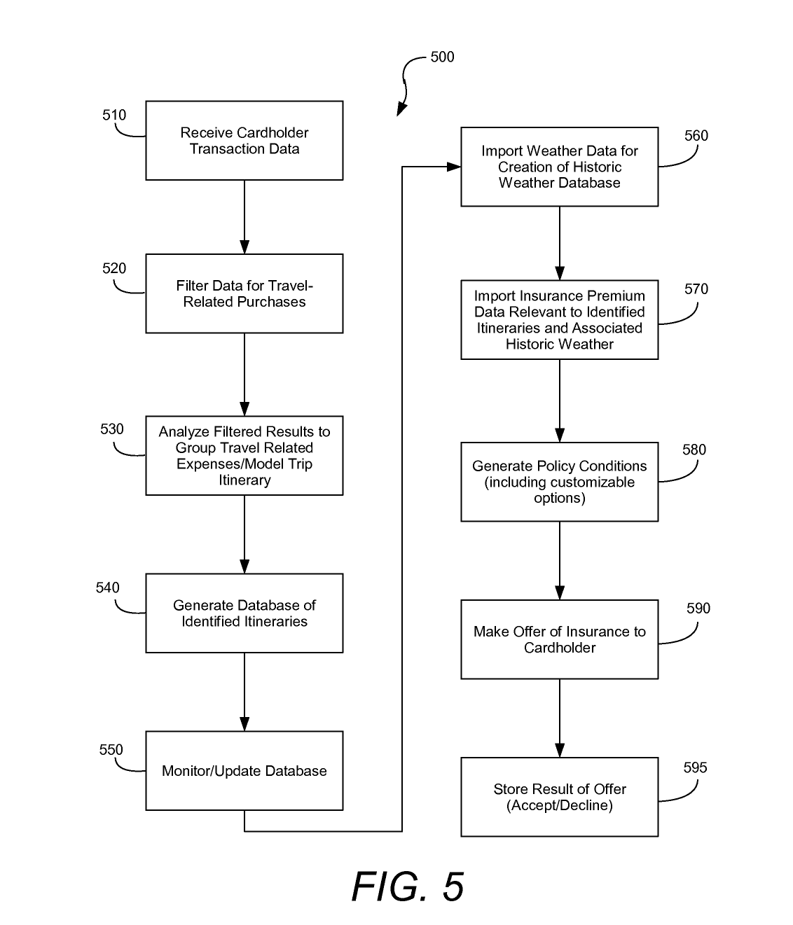

FIG. 5 illustrates an exemplary computer process flow for generating a database of identified travel itineraries, correlating the itineraries with historic weather data and weather forecasts for generating weather-related guarantees for the itineraries, and making offers of guarantee to cardholders for payment transactions based on weather-related criteria. Process 500 includes receiving general cardholder transaction data (block 510). As set forth above with respect to FIG. 3, data may be obtained through active or passive means, including ISO 8583 message information received over the payment card network and stored for example, in a card network database. The data may include cardholder transactions filtered (block 520) according to any number of select parameters or characteristics in order to identify payment card transactions relating to vacation or travel purchases of a given cardholder, as well as other types of transactions associated with these purchases. In block 530, an analysis of the filtered data is performed in order to associate multiple purchases that appear to be associated with the time/location of an identified trip by the same cardholder, for constructing a model itinerary for each identified trip. This model includes a collection of trip attributes, such as location, duration, activities, and the like, which may be relevant to determine appropriate weather-related insurance coverage. Each of these identified itineraries may be stored in a database (block 540). The database may be continually monitored and updated with additional identified cardholder transactions related to any itinerary stored therein (block 550).

Once a database of cardholders and associated itineraries has been established, weather data may be fed to the system (e.g. from a third party provider) which corresponds to the times and locations identified in each itinerary (block 560). The weather data may include both historic weather trends and information, as well as future weather forecasts for particular geographic regions. In block 570, insurance premium data (e.g. from third party providers) may be used to generate weather-related guarantee price information for all or part of a given modeled itinerary. From this pricing information, one or more insurance policy (guarantee) options may be generated. Such options may include, for example, blanket trip coverage against one or more unfavorable weather conditions, or partial coverage options which provide a cardholder the ability to customize coverage of his trip according to specific criteria or conditions (block 580). After insurance policy options have been generated, an offer of insurance may be made (e.g. by the card network) to the cardholder (block 590). In response to the offer, a cardholder may indicate a desire to purchase a particular insurance policy, or a policy including conditions of his choosing. If an offer is accepted, the system may associate an accepted policy with a particular itinerary (block 595). Likewise, if the offer of insurance is declined, an indication of the decline or absence of coverage may be associated with the itinerary.

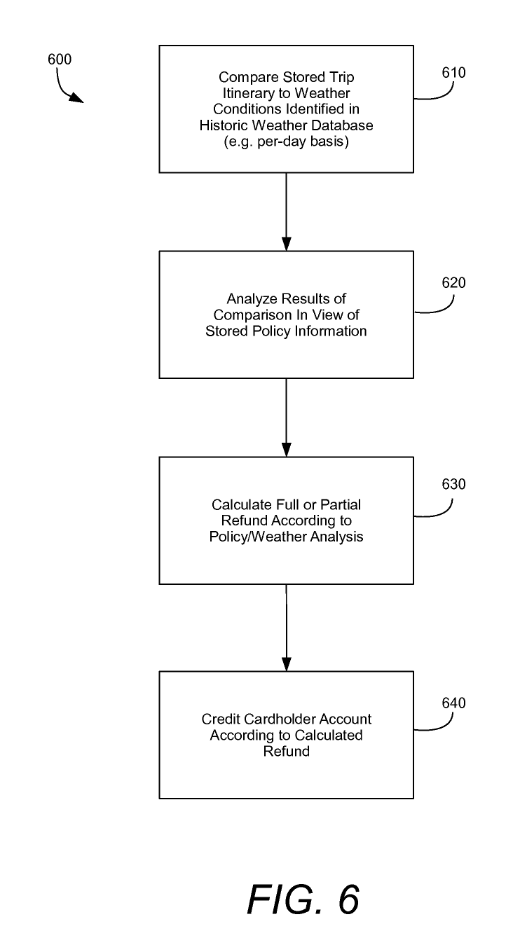

FIG. 6 illustrates another exemplary computer process flow for determining payout of a policy guarantee and automatically generating refunds to card members in the event a weather-related condition of the insurance policy has been met (or not met). Process 600 includes comparing one or more weather parameters (e.g. precipitation, solarity, temperature, etc.) received via a weather data feed associated with the select travel destination, with the weather-related criteria or conditions specified in the policy. Comparison of weather conditions and weather-related criteria may be made on a day- by-day basis or other specified time period (block 610). An analysis between the weather data from the feed and the conditions of the insurance policy is performed in block 620. If one or more of the weather-related conditions are met that trigger payment according to the policy, a refund calculation is automatically initiated by the system (block 630). For example, if historic weather data indicates that there was rainfall on a number of days during a beach vacation, and the insurance policy provided coverage for such weather conditions on a day-to-day basis, a refund may be calculated taking into account, for example, the number of days the stated policy condition was met in order to determine a total refund amount. In block 640, the processor is configured to automatically initiate a refund transaction via the payment card network whereby the cardholder's account may be automatically credited without further action by the cardholder.

### EXAMPLE

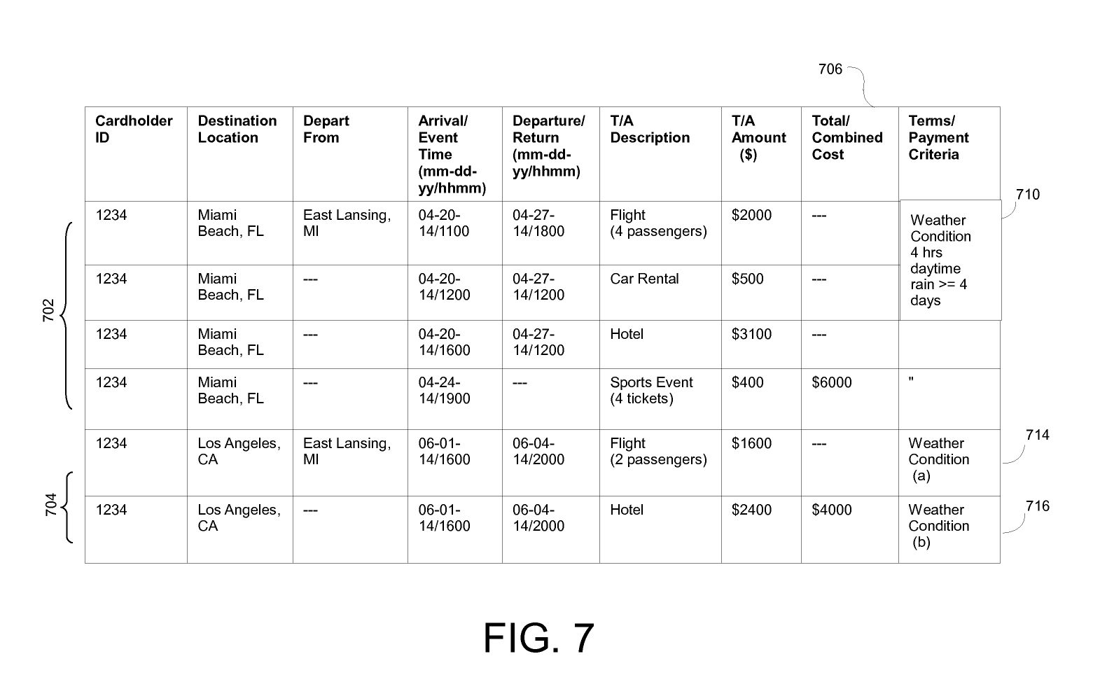

By way of non-limiting example, referring to FIG. 7 in conjunction with FIGS. 3-6, the following depicts processing operations relating to the creation, distribution, administration, management and communication of data relating to guarantees or insurance policies on payments made over a payment card system for protecting against loss of value, relating to unpredictable weather or other natural phenomenon. In one embodiment, a cardholder purchases over a payment card network an airline flight from East Lansing, Mich. to Miami Beach, Fla. for four people having a departure/arrival date of April 20 and a return date of April 27. A payment card transaction for a rental vehicle with pickup/dropoff dates of April 20 and April 27 at the Miami Airport is also made via the payment card network. Hotel accommodations in Miami Fla. are further purchased by the cardholder over the payment card network with a check-in date of April 20 and a check-out date of April 27. An additional payment card purchase transaction is made by the cardholder for four tickets at an outdoor sporting event in Miami (professional baseball game) scheduled on April 24. In a further example, additional cardholder payment card purchase transactions are made that include hotel and flight purchases for two people from June 1-June 4 to Los Angeles, Calif. by said cardholder.

The transaction records for each of the payment card transactions provided in ISO 8583 messages along with supplemental purchase information from addenda associated with the transactions are received and stored in the transaction data base (320 of FIG. 3). The system may filter and process the transaction records based on various criteria, including aggregating various transaction records, in order to generate separate cardholder itineraries for the cardholder such as those depicted as 702 and 704 in FIG. 7.

The system may be configured to calculate a combined cost 706 associated with each itinerary and in one embodiment, generate a weather related insurance offer for submission to the cardholder. The weather related insurance offer may be generated based on one or more of the purchase transaction amount(s), the duration, geographic location, historic seasonal and forecasted weather data, and the like.

A data base of predetermined weather criteria or conditions linked to particular geographic regions may be used, along with historical weather conditions and trends, in order to determine an offer of weather-related insurance for a particular trip. For example, for itinerary 702, the data base may be configured based on the destination location, transactions costs, trip duration, premium data, and historical and forecasted weather, to offer a weather insurance policy that reimburses the cardholder for 25% of the itinerary cost 706 for a given payment price (e.g. $100) in the event that the associated geographic destination (i.e. Miami) receives rain during the daytime (defined e.g. between 7 am-7 pm) for at least 4 hours per day for 4 or more of the 8 day duration of the trip. The guarantee may be provided by the merchant, card network or third party insurance provider, for example. If the cardholder accepts the offer, terms of the insurance policy may be stored in the data base along with the criteria or conditions for payment (i.e. 4 hours of daytime rain for 4 of more days) as depicted by reference numeral 710. A rules based engine may be used to monitor compliance with the terms of the weather-related guarantee.

For example, upon commencement of the trip, the system may be configured to receive a weather feed (e.g. 382 in FIG. 3) on a periodic basis (e.g. every half hour) during at least a portion of the day (e.g. daytime) indicating whether the given destination (e.g. Miami) has received rain in that interval. The system will compare the data from the weather feed with the particular payout criteria and monitor the results over the duration of the trip to determine whether the criteria has been met. If the processor (e.g. 390 of FIG. 3) determines based on the weather feed that the weather condition or criteria for an event insured has been satisfied, the processor checks the rules data base to calculate the payout amount. In this case, the processor determines the payout amount to be 25% multiplied by the itinerary cost 706 ($6000) so as to equate to $1500 that is refunded to the cardholder. The refund may be apportioned based on each transaction amount in the itinerary so that multiple refund transactions equating to the total refund amount may be automatically provided over the card network to the cardholder.

In an embodiment, the system (e.g. processor 390 in FIG. 3) may be configured to send a request to the cardholder to assess whether the cardholder may be interested in purchasing trip insurance for a select itinerary. The details of the itinerary as determined by the system based on the transactions data may also be provided in the request to the cardholder. An input user interface may be provided with selectable options for the cardholder to customize particular weather related conditions or criteria, depending on the nature of the trip. For example, in regards to itinerary 704 shown in FIG. 7, the user may have the option to customize selection so as to identify weather condition a): 4 hours of daytime rain for 4 of more days; and weather condition b): afternoon (e.g. defined as 11 am-4 pm) temperatures falling under 60° F. for 3 or more days. In the event either of these conditions is met, a payout of 25% of the itinerary price may be refunded. Of course, the premium may be increased based on the terms of the weather-related guarantee and associated payout conditions. In this embodiment if the cardholder accepts the offer, terms of the insurance policy may be stored in the data base along with the criteria or conditions for payment as indicated by reference numerals 714 and 716. In this case, the system is configured to receive weather data feed parameters including at least temperature and rainfall on a periodic basis over the duration of the trip for comparison with the conditions 714, 716 stored in the data base, for determining whether the policy is triggered by the satisfaction of one or more of said conditions.

It is to be understood that the above-identified examples are merely exemplary, and thus may be modified according to the requirements of a particular application. Weather guarantee policies of fixed priced amounts may be provided and monitored based on one or more weather related conditions. Alternatively, insurance coverage amounts consisting of a fixed price component and a variable component based on the magnitude of coverage being offered, and the corresponding conditions being insured against, may also be provided. Codes based on the specific weather conditions (e.g. amount of rain or snow, number of days of sunshine, temperature ranges, etc) may be returned and stored in the system data base for comparison with current weather data as provided via a weather feed or weather data base for determining whether payment on the policy is required. Such a validation routine may be performed in real time, or as part of a post processing routine after the trip (itinerary) has been completed.

The flow charts described herein do not imply a fixed order to the steps, and embodiments of the present invention may be practiced in any order that is practicable. In embodiments, one or more steps of the methods may be omitted, and one or more additional steps interpolated between described steps. Note that any of the methods described herein may be performed by hardware, software, or any combination of these approaches. For example, a non-transitory computer-readable storage medium may store thereon instructions that when executed by a processor result in performance according to any of the embodiments described herein. In embodiments, each of the steps of the methods may be performed by a single computer processor or CPU, or performance of the steps may be distributed among two or more computer processors or CPU's of two or more computer systems. In embodiments, one or more steps of a method may be performed manually, and/or manual verification, modification or review of a result of one or more processor-performed steps may be required in processing of a method.

The embodiments described herein are solely for the purpose of illustration. Those in the art will recognize that other embodiments may be practiced with modifications and alterations limited only by the claims.

1. A system for generating offers of insurance on payment card transactions for protection against weather or other natural phenomenon, the system comprising:
one or more data storage devices containing payment card transaction data of a plurality of customers, the payment card transaction data including at least customer information and transaction amounts;
one or more processors;
a memory in communication with the one or more processors and storing program instructions, the one or more processors operative with the program instructions to:
identify a customer who has made travel related expenditures based on processing payment card transaction data for future travel, the payment card transaction data including at least travel destination, and transaction amounts;
analyze said payment card transaction data to identify relationships between different payment card transactions for generating an estimated travel itinerary for the identified customer;
compare the estimated travel itinerary for the identified customer to historic, current or forecasted weather data corresponding to the travel destination;
generate an offer of travel insurance including weather-specific conditions based on comparison between the estimated travel itinerary and the weather data.

2. The system of claim 1, wherein the one or more processors is operative with the program instructions to store in a database data corresponding to the weather- specific conditions of the insurance agreement.

3. The system of claim 2, wherein the one or more processors is operative with the program instructions to compare one or more weather conditions at the travel destination during at least part of the travel itinerary, with weather-specific conditions of the insurance agreement, for determining whether an insurance payout is required.

4. The system of claim 3, wherein the one or more weather conditions include one or more of temperature, humidity, solarity, wind speed, and precipitation.

5. The system of claim 4, wherein the one or more processors is operative with the program instructions to automatically generate a refund transaction over a payment card network upon determining an insurance payout is required.

6. The system of claim 1, wherein the one or more processors is operative with the program instructions to receive via a payment card network ISO 8583 message data concerning said travel related expenditures based on processing payment card transaction data.

7. A computer-implemented method for generating offers of insurance on payments card transactions for protection against weather or other natural phenomenon, the method comprising:
storing in a database payment card transactions related to travel based on processing payment card transaction data of a plurality customers and merchants, the payment card transaction data including at least customer information, geographical information, travel destination information and information identifying a category of good or service associated with the transaction;
accessing comprising historic, current or forecasted weather data corresponding to the time and location of the identified travel destinations;
analyzing the payment card transaction data to identify relationships between different payment card transactions for generating an estimated travel itinerary for the identified customer;
comparing the estimated travel itinerary for the identified customer to historic, current or forecasted weather data corresponding to the travel destination;
generating an offer of travel insurance including weather-specific conditions based on the comparison between the estimated travel itinerary and the weather data.

8. The method of claim 7, further comprising storing in a database data corresponding to the weather-specific conditions of the insurance agreement.

9. The method of claim 8, further comprising comparing one or more weather conditions at the travel destination during at least part of the travel itinerary, with weather-specific conditions of the insurance agreement, for determining whether an insurance payout is required.

10. The method of claim 9, wherein the comparing one or more weather conditions comprises comparing one or more of temperature, humidity, solarity, wind speed, and precipitation with the weather-specific conditions of the insurance agreement.

11. The method of claim 9, further comprising automatically generating a refund transaction over a payment card network upon determining an insurance payout is required.

12. The method of claim 7, further comprising receiving via a payment card network ISO 8583 message data concerning said travel related expenditures based on processing payment card transaction data.

13. A system for generating offers of insurance on payments card transactions received via a payment card network for protection against weather or other natural phenomenon, the system comprising:
a database for storing payment card transactions related to travel based on processed payment card transaction data of a plurality customers and merchants, the payment card transaction data including at least customer information, geographical information, travel destination information and information identifying a category of good or service associated with the transaction;
an analytics processor configured to analyze the payment card transactions in the database to identify relationships between different payment card transactions for generating an estimated travel itinerary for a customer, wherein each estimated itinerary is associated with a common travel destination and time interval;
a processor configured to compare the estimated travel itinerary for the identified customer to historic, current or forecasted weather data corresponding to the travel destination, and generate an offer of travel insurance including weather-specific conditions based on the comparison.

14. The system of claim 13, further comprising a user interface for receiving as input one or more weather-specific conditions for generating an offer of travel insurance.

15. The system of claim 14, wherein the processor is further configured to compare one or more weather conditions at the travel destination during at least part of the travel itinerary, with weather-specific conditions of the insurance agreement, for determining whether an insurance payout is required.

16. The system of claim 15, wherein the processor is further configured to automatically generate a refund transaction over a payment card network upon determining an insurance payout is required.

17. The system of claim 13, wherein the one or more weather conditions include one or more of temperature, humidity, solarity, wind speed, and precipitation.
